(19) United States
(12) Patent Application Publication
(10) Pub. No.: US 2002/0133329 A1
(43) Pub. Date: Sep. 19, 2002

(54) Simulation program product, method and system utilizing a plurality of simulation-models

(76) Inventors: Makoto Kano, Inagi-shi (JP); Satoshi Sekine, Sagamihara-shi (JP); Akira Higashide, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/022,876

(22) Filed: Dec. 20, 2001

(30) Foreign Application Priority Data
Dec. 25, 2000 (JP) 2000-393532
Mar. 16, 2001 (JP) 2001-077040

(51) Int. Cl. G06F 9/45

(52) U.S. Cl. 703/22

(57) ABSTRACT

A model selector selects a simulation model on the basis of a selection condition set by a setting device to read out the simulation model from a model data base. A simulation calculator calculates the simulation by using this read out simulation model on the basis of the initial state and the simulation condition set by the setting device.

### CROSS-REFERENCE TO RELATED APPLICATIONS

This application is based upon and claims the benefit of priority from the prior Japanese Patent Applications No. 2000-393532, filed Dec. 25, 2000; and No. 2001-077040, filed Mar. 16, 2001, the entire contents of both of which are incorporated herein by reference.

### BACKGROUND OF THE INVENTION

1. Field of the Invention

The present invention relates to a simulation utilizing a plurality of simulation-models. More specifically, the present invention relates to a simulation program product, method and system utilizing a plurality of simulation-models.

2. Description of the Related Art

According to conventional simulation technology, one simulation model is built with respect to a target system to be simulated so that simulation calculation is carried out.

Accordingly, when the built simulation model is a detailed model, simulation by the use of the present model expresses a behavior of the target system accurately, so that this simulation has an advantage in that it is capable of providing highly-precise simulation results. However, this involves a defect in that this a powerful calculation means and a very long calculation time are necessary.

On the contrary, when the built simulation model is a simple model, simulation by the use of the present model has an advantage such that it is capable of reducing the time and resources needed for calculation. However, this simulation also has a defect, in that the accuracy of the simulation result is lowered.

Alternatively, a study of the integrity between models having different degrees of details is presented in “Computational Strategies for Disaggregation R. W. Franceschini, A. S. Wu, A. Mukherjee, Proceedings of the ninth Conference on Computer Generated Forces and Behavioral Representation, May 16-18, 2000 Orlando, Fla.” However, there is no description with respect to the operating method of a simulation system therein.

As described above, according to conventional simulation technology, if simulation is carried out using a highly-detailed model, calculation time is very long. On the contrary, if simulation is carried out using a low-detail model, the accuracy of the simulation result is decreased.

### BRIEF SUMMARY OF THE INVENTION

An object of the present invention is to provide a simulation program product, method and system capable of satisfying both the demand for simulation accuracy and for reduction in the calculation time.

In order to attain the above object, a simulation program product according to an aspect of the invention is a simulation program product for controlling a computer having a model data base, the product storing a plurality of simulation models, which simulate the operation of a subject, and comprising:condition inputting means for causing the computer to set an initial state of the subject to be simulated, a simulation condition and a selection condition of the simulation model; model selecting means for causing the computer to select the simulation model on the basis of the set selection condition of the simulation model and to read out the selected simulation model from the model data base; simulation calculating means for causing the computer to apply the set initial state of the subject and the set simulation condition to the read out simulation model and to calculate the simulation; and result outputting means for causing the computer to output a result of the simulation calculation.

In order to attain the above object, a simulation method according to an aspect of the invention is a simulation method utilizing a model data base in which a plurality of simulation models simulating the operation of the subject are stored, comprising: inputting a condition to set an initial state of the subject, a simulation condition and a selection condition of the simulation model; selecting the simulation model on the basis of the set selection condition of the simulation model and reading out the selected simulation model from the model data base; applying the set initial state and the set simulation condition to the read out simulation model and calculating a simulation; and outputting a calculation result by the simulation calculating step.

In order to attain the above object, a simulation system according to an aspect of the invention is a simulation system for utilizing a model data base which stores a plurality of simulation models, which simulate the operation of a subject comprising:a setting device which sets an initial state of the subject, a simulation condition and a selection condition of the simulation model; a model selector which selects a simulation model on the basis of the selection condition set by the setting device to read out the simulation model from the model data base; a simulation calculator which calculates the simulation by using a simulation model read out from the model selector on the basis of the initial state and the simulation condition set by the setting device; and an outputting device which outputs the calculation result by the simulation calculator.

In order to attain the above object, a simulation program product according to an aspect of the invention is a simulation program product for controlling a computer having a model data base, the product storing a plurality of simulation models, which simulate the operation of a subject, and comprising:condition inputting means for causing the computer to set an initial state of the subject to be simulated, a simulation condition and a selection condition of the simulation model; model selecting means for causing the computer to select the simulation model on the basis of at least one state of the subject state and the environment state and the set selection condition of the simulation model and to read out the selected simulation model from the model data base; simulation calculating means for causing the computer to apply the set initial state of the subject and the set simulation condition to the read out simulation model to calculate the simulation as well as for causing the computer to input at least one state of the subject state and the environment state obtained from the calculation in the model selecting means; and result outputting means for causing the computer to output a result of the simulation calculation.

In order to attain the above object, a simulation method according to an aspect of the invention is a simulation method utilizing a model data base in which a plurality of simulation models simulating the operation of the subject are stored, comprising: inputting a condition to set an initial state of the subject, a simulation condition and a selection condition of the simulation model; selecting the simulation model on the basis of at least one of the subject state and the environment state and the set selection condition of the simulation model and reading out the selected simulation model from the model data base; applying the set initial state and the set simulation condition to the read out simulation model and calculating a simulation as well as inputting at least one of the subject state and the environment state obtained from the calculation, in the model selecting means; and outputting a result of the simulation calculating.

In order to attain the above object, a simulation system according to an aspect of the invention is a simulation system for utilizing a model data base which stores a plurality of simulation models, which simulate the operation of a subject comprising:a setting device which sets an initial state of the subject, a simulation condition and a selection condition of the simulation model; a model selector which selects the simulation model on the basis of at least one state of the subject state and the environment state and the set selection condition of the simulation model to read out the selected simulation model from the model data base; a simulation calculator which applies the set initial state and the set simulation condition to the read out simulation model to calculate the simulation as well as inputs at least one state of the subject state and the environment state to be obtained from the calculation; and an outputting device which outputs the calculation result by the simulation calculator.

According to the execution of a simulation program product on a computer, in the execution of a simulation method and a simulation system according to one aspect of the present invention, if a selection condition of a model is provided, it is possible to carry out the simulation by combining the simulation models having different degrees of details in space on the basis of this selection condition or switching the simulation models having the different degrees of the details in time on the basis of this selection condition. Further, with respect to an important portion, it is possible to carry out high-precision simulation by using a model with a high degree of details and with respect to a portion which is not so important, and it is possible to carry out simulation in a short period of time by using a model with a low degree of details. Therefore, it is possible to simultaneously realize a high accuracy for a model with a high degree of details, and a short calculation time for a model with a low degree of details.

According to the execution of a simulation program product on a computer, the execution of a simulation method and a simulation system according to another aspect of the present invention, in addition to the effect of the above-described one aspect of the invention, during carrying out the simulation, a state of a moving subject and a state of an environment are compared to a selection condition of a model, so that it is possible to change a simulation model dynamically. In other words, under the state that an error is small, a simulation model with a low degree of details is used and under the state that an error is large, a simulation model with a high degree of details is used, so that it is possible to reduce the resources needed for calculation, and the calculation time, while decreasing errors as a whole.

### BRIEF DESCRIPTION OF THE SEVERAL VIEWS OF THE DRAWING

FIG. 1 is a block diagram for illustrating a constitution of a simulation system according to a first embodiment of the present invention;

FIG. 2 is a diagram for illustrating an example of a model data base according to the first embodiment;

FIG. 3 is a drawing for illustrating an example of a selection condition of a model according to the first embodiment;

FIG. 4 is a drawing for illustrating an example of a selection condition of a model according to the first embodiment;

FIG. 5 is a drawing for illustrating an example of a selection condition of a model according to the first embodiment;

FIG. 6 is a drawing for illustrating an example of a selection condition of a model according to the first embodiment;

FIG. 7 is a flow chart for explaining the operation of the first embodiment;

FIG. 8 is a block diagram for illustrating a constitution of a simulation system according to a second embodiment of the present invention;

FIGS. 9A to 9C are a drawing for illustrating an example of a selection condition of a model according to the second embodiment;

FIG. 10 is a flow chart for explaining the operation of the second embodiment;

FIG. 11 is a schematic view for explaining a micro model of a traffic flow network according to a third embodiment of the present invention;

FIG. 12 is a schematic view for explaining a micro model according to the third embodiment;

FIG. 13 is a schematic view for illustrating an example such that a traffic flow network according to the third embodiment is divided into fixed segments;

FIG. 14 is a schematic view for illustrating an example such that a micro model is applied in only one segment according to the third embodiment;

FIG. 15 is a schematic view for illustrating an example such that a micro model is applied in a segment in an arbitrary range according to the third embodiment;

FIG. 16 is a schematic view for illustrating an example such that a micro model is applied in a vehicle according to the third embodiment and in a range therearound;

FIG. 17 is a schematic view for explaining the conversion of a micro model and a macro model according to the third embodiment;

FIG. 18 is a schematic view for explaining a flow of the vehicles when the micro model and the macro model are connected to each other according to the third embodiment;

FIG. 19 is a block diagram for illustrating a constitution of a simulation system according to a fifth embodiment of the present invention;

FIG. 20 is a flow chart for explaining the operation according to the fifth embodiment;

FIG. 21 is a schematic view for explaining a macro model in a traffic flow network according to a sixth embodiment of the present invention;

FIG. 22 is a schematic view for explaining a micro model according to the sixth embodiment;

FIG. 23 is a schematic view for explaining a traffic jam in a macro model according to the sixth embodiment;

FIG. 24 is a schematic view for explaining the micro model during traffic jam according to the sixth embodiment;

FIG. 25 is a schematic view for explaining a constitution of a parameter converting unit according to the sixth embodiment; and

FIG. 26 is a schematic view for explaining a constitution of a parameter converting unit of a simulation of a fishing industry according to a seventh embodiment of the present invention.

### DETAILED DESCRIPTION OF THE INVENTION

Respective embodiments according to the present invention will be described with reference to the drawings below.

According to the respective embodiments to be described later, for example, the term “a state of a moving subject” represents information with respect to a density of the moving subjects and a state of the moving subject, such as an average speed of the moving subject and the like.

The term “a state of an environment” represents, for example, information indicating a state of an environment other than the moving subject, such as geography, geographic information, weather and the like.

The term “a state of a periphery” represents, for example, information indicating a state of the periphery of a moving subject to attract attention such as a density of other moving subjects around a certain moving subject, an average speed of another moving subject and a position of another moving subject, such as the position of a fish shoal.

First Embodiment

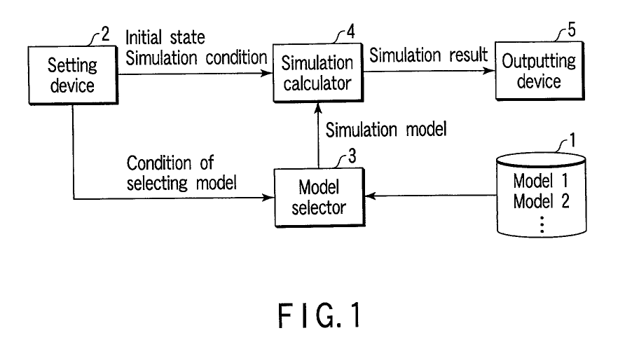

FIG. 1 is a block diagram for illustrating a constitution of a simulation system according to a first embodiment of the present invention. This simulation system simulates the movement of a vehicle as a moving subject, which is a target of simulation.

The present system is provided with a setting device 2 as condition inputting means, a model selector 3, a simulation calculator 4 and an output device 5 as a result outputting means, and utilizes a model data base 1.

In this case, the model data base 1 holds a plurality of simulation models having different degrees of details capable of being read from the model selector 3.

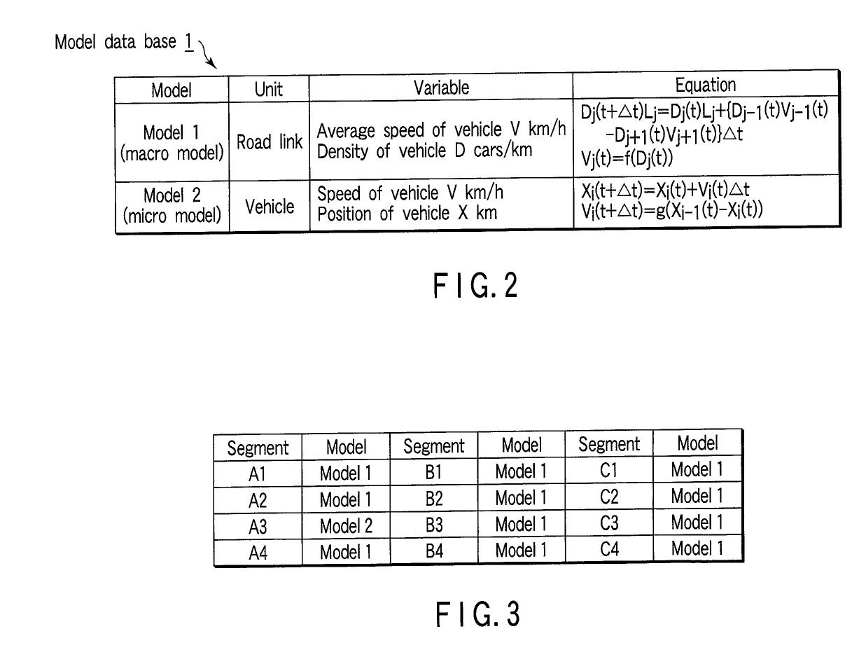

In this case, an example of the model data base 1 is shown in FIG. 2. According to this example, a model 1 and a model 2 serving as a model are registered. Then, the model 1 or the model 2 is read out by the selection of the model selector 3.

Respective reference numerals Dj (t), Lj, Vj (t) and f ( ) of the model 1 shown in FIG. 2 denote the following contents.

Dj (t):a density of the vehicles of a link j at a time t

Lj:a link length of the link j

Vj (t):an average speed of a vehicle of the link j at a time t

f ( ):a function indicating a relation between a density of the vehicles and an average speed

Respective reference numerals Xᵢ (t), Vᵢ (t), g (t) and Δt of the model 2 shown in FIG. 2 denote the following contents.

Xᵢ (t):a position of a vehicle i at a time t

Vᵢ (t):a speed of the vehicle i at a time t

g (t):a function indicating a relation between a distance between two cars and speeds between the two cars

Δt:unit time

Alternatively, the model 1 is a macro model. This is an example of a simulation model requiring a lower amount of calculation and a low degree of precision. The model 2 is a micro model. This is an example of a simulation model requiring a large amount of calculation and a high degree of precision.

The setting device 2 has a function to set an initial state of a moving subject as a subject to be simulated and a simulation condition in the simulation calculator 4 by means of a user's operation and a function to set a condition of a selecting model by the model selector 3 by means of the user's operation.

In this case, as the initial state, for example, an initial position of the moving subject, an initial speed and the like are considered. As a simulation condition, a width of a space, geography, a road, a simulation time and the like are considered.

Alternatively, for example, the selection condition of the model comprises the following (C1) through (C9).

(C1):directly designating a simulation model

(C2):dividing a space at which the moving subject is placed into some segments and designating a simulation model for each segment

(C3):designating a partial segment in the space and a simulation model in the segment

(C4):dividing a simulation time into a plurality of times and designating a simulation model for each time

(C5):designating a partial time in the simulation time and the simulation model in the time

(C6):dividing a space and a simulation time into a plurality segments and designating a simulation model in association with a combination of respective times and the segments

(C7):designating a partial time in the simulation time and a partial segment in the space, and designating a simulation model in association with a combination of this time and the segment

(C8):dividing a space into a plurality of segments and designating a simulation model of a segment in which the moving subject is placed

(C9):designating a moving subject and designating a simulation model in association with an area in a certain range of which the approximate center is the present moving subject

In this case, for example, the selection conditions to be set by the model selector 3 are illustrated in FIG. 3 through FIG. 6.

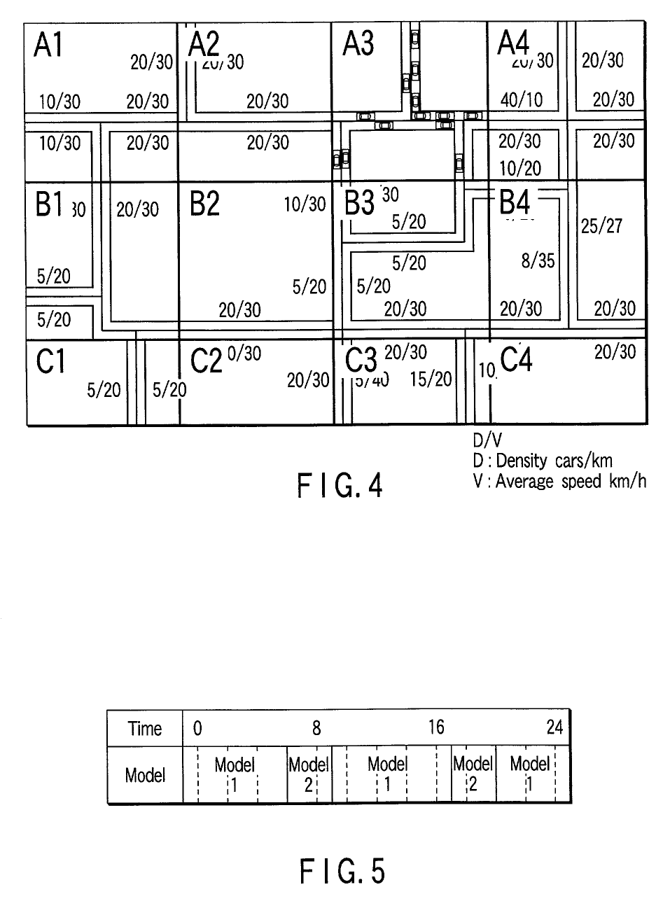

FIG. 3 shows a specific selection condition of a model in the case of (C2). This condition shown in FIG. 3 is exemplified in FIG. 4.

As shown in FIG. 4, an area, in which the moving subject is moving, is shown in a segmental drawing. Accordingly, the moving of the moving subject in the present area is replaced with the moving of the moving subject on the illustrated segmental drawing. The segment drawing shown in FIG. 4 is divided into segments A1 through A4, B1 through B4 and C1 through C4. Further, a model is set in each segment.

Specifically, a model 2 is set in the segments A3 and a model 1 is set in the other segments. The model selector 3 decides a simulation model for each segment on the basis of this information.

Alternatively, FIG. 5 is a specific selection condition of a model in the case of (C4). According to this example, the model selector 3 selects the model 2 from 06:00 hrs to 09:00 hrs and 17:00 hrs to 20:00 hrs, so that the simulation calculator 4 will carry out the simulation on the basis of the present model 2.

Therefore, for example, it is possible that the period of time during which a road is congested is only simulated in detail and other periods of time during which the road is relatively empty are simulated by the model 1.

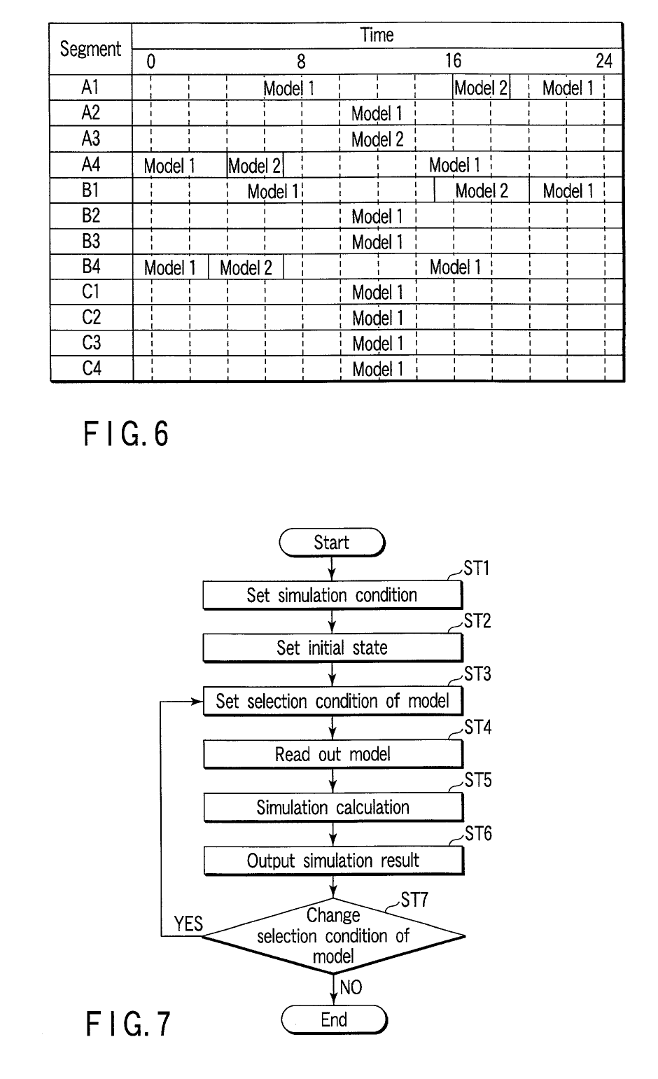

Alternatively, FIG. 6 shows a specific selection condition of a model in the case of (C6). According to this example, the segment A1 simulates a period of time from 16:00 hrs to 19:00 hrs by the model 2. The segment A1 simulates a period of time other than the period of time from 16:00 hrs to 19:00 hrs on the basis of the model 1. The segment A4 simulates a period of time from 04:00 hrs to 07.00 hrs on the basis of the model 2. Further, the segment A4 simulates a period of time other than the period of time 04:00 hrs to 07:00 hrs on the basis of the model 1.

The model selector 3 has a function to select any one of simulation models within the model data base 1 on the basis of the selection condition of the model set by the setting device 2 so as to read the present simulation model from the model data base 1 and a function to transmit this simulation model to the simulation calculator 4.

Alternatively, when a simulation model is different for each segment, each simulation model is outputted to the simulation calculator 4 with being combined with a segment. In this case, as a specific simulation model to be outputted to the simulation calculator 4, there is an equation or the like in association with each model shown in an example of FIG. 2.

The simulation calculator 4 has a function to calculate the simulation on the basis of the initial state of the moving subject and the simulation condition set by the setting device 2 by using a simulation model readout from the model selector 3.

The output device 5 has a function to output the calculation result by the simulation calculator 4. Specifically, for example, the output device 5 has a function to display the calculation result as an animation and a graph, or, to a file.

Alternatively, such a simulation system is capable of being realized by hardware and/or software. When this simulation system is realized by software, a simulation program product is provided. For example, the present product is a storage medium. By installing this storage medium with the program stored on it in a computer and executing this program on a computer, the present system is realized.

Next, the operation of the simulation system configured as described above will be explained by using a flow chart shown in FIG. 7.

The setting device 2 sets a simulation condition with respect to an environment, such as a size of a space, geography, a road, a simulation time and the like in the simulation calculator 4 (ST1) according to an operation by the user, and the setting device 2 sets an initial state of the moving subject as one of the simulation conditions (ST2).

Subsequently, the setting device 2 sets a selection condition of a simulation model in the model selector 3 according to the user's intention (ST3).

For example, a content of the simulation is divided by a portion, which causes an interest such as a segment and/or a time. Alternatively, with respect to a portion, which causes many interest in respective portions specified by the division, a simulation model having a large amount of the calculation and a high degree of precision is designated. On the other hand, with respect to a portion, which causes less interest in respective portions specified by the division, a simulation model having a less amount of the calculation and a low degree of precision is designated.

The model selector 3 selects any one of the simulation models within the model data base 1, on the basis of this condition of the selecting model, to read out the present simulation model from the model data base 1 (ST4). At the same time, the model selector 3 transmits this simulation model to the simulation calculator 4.

The simulation calculator 4 performs simulation using the simulation model read out, on the basis of the initial state of the moving subject and the simulation condition set by the setting device 2 (ST5). Then, the simulation calculator 4 transmits the simulation calculation result to the output device 5.

The output device 5 displays this simulation calculation result and outputs it (ST6).

Next, seeing the simulation calculation result the user selects whether or not the simulation should be carried out again with changing the selection condition of the model (ST7). When the simulation should be carried out again, the selection condition of the model is returned to the step ST3, and the same operation will be repeated.

As described above, according to the present embodiment, it is possible to perform a series of simulation calculations with changing each simulation model.

Thereby, for example, with respect to an important portion i.e. large interest, it is possible to carry out high-precision simulation by using the micro model 2 with a high degree of detail. With respect to a less important portion, it is possible to carry out simulation in a short period of time by using the micro model 2 with a low degree of detail.

Therefore, it is possible to carry out simulation so as to realize high-precision and a short calculation time at the same time.

Alternatively, when there is a place which requires a model with a high degree of detail and a place in which a model with a low degree of detail is enough depending on the difference of a geographical condition, for example, the difference between an urban area and a rural area, it is possible to decide a degree of detail of a model by designating a segment in a space. Thereby, it is possible to reduce the resources needed for calculation, and the calculation time of the simulation, as well as to obtain a high-precision simulation result.

Alternatively, when there is a place which requires a model with a high degree of detail and a place in which a model with a low degree of detail is enough depending on the difference of a condition in time, for example, the difference between a period of commuting time in morning and evening and a midnight or the difference between a weekday and a holiday, it is possible to decide a degree of detail of a model by designating a time. Thereby, it is possible to reduce the resources needed for calculation, and the calculation time of the simulation, as well as to obtain a high-precision simulation result.

Additionally, when the user would like to know the behavior of a specified moving subject as a result of simulation, the user utilizes a model with a high degree of detail with respect to a circumference of this moving subject. Further, the user utilizes a model with a low degree of detail with respect to other places. Hereby, it is possible to save a calculation resource and a calculation time of the simulation as well as it is possible to obtain a high-precision simulation result.

Second Embodiment

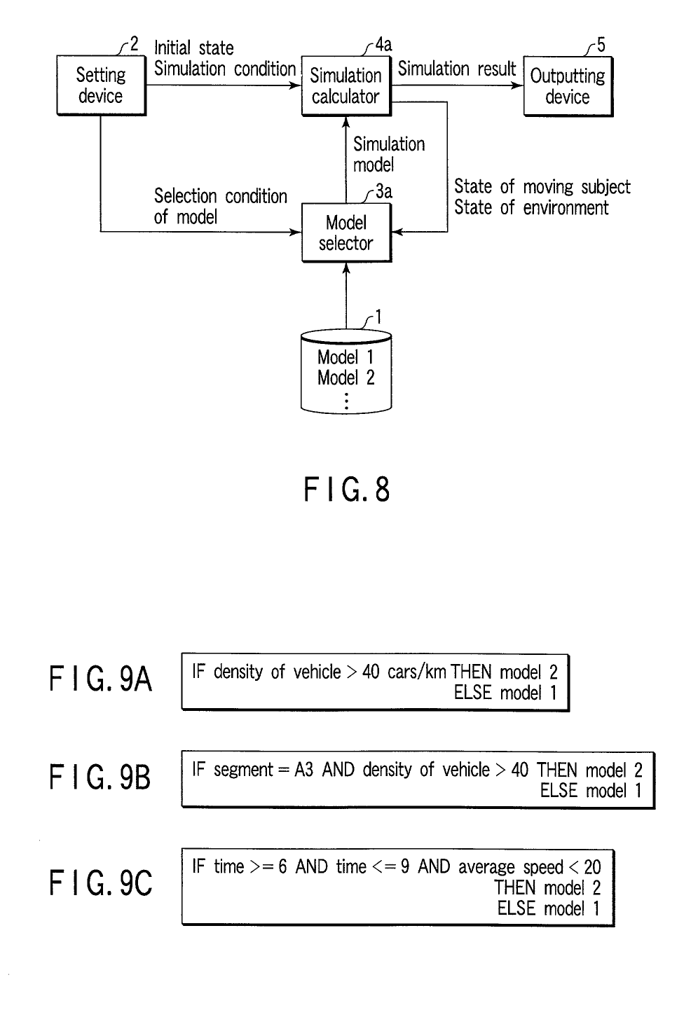

FIG. 8 is a block diagram for illustrating a constitution of a simulation system according to a second embodiment of the present invention. With respect to the parts the same as those shown in FIG. 1, identical reference numerals are given and detail explanations thereof are omitted, and the different parts will be described below. Additionally, with respect to the following respective embodiments, a duplicate explanation is omitted in the same way.

In other words, the present embodiment is a modification of the first embodiment. In the present embodiment, a simulation model is changed depending on a state defined by a calculation result of the simulation. Specifically, a system according to the present embodiment is provided with a model selector 3a having a model changing function and a simulation calculator 4a in addition to the functions.

Alternatively, as a model selection upon changing a model (C10), designating a simulation model in association with a state of a moving subject and/or a state of an environment is set from the setting device 1 to the model selector 3a. Alternatively, this model selection upon changing a model (C10) is set with being combined with the selection conditions of the model (C1) through (C9) or this model selection upon changing a model (C10) is set by itself. However, the model selection upon changing a model (C10) is not always needed to be set so that it changes both of a high-precision model and a low-precision model but it may be set so as to change at least one of them.

In this case, the model selector 3a has a function to enable selection of a simulation model on the basis of the present inputted state and the selection condition of the model set by the setting device 1 when a state of the moving subject and/or a state of the environment are inputted from the simulation calculator 4a in addition to the functions. Further, the model selector 3a also has a differentiation function for deciding whether or not the newly selected simulation model is different from a simulation model which is being used at the present time, and if the result of the decision indicates that they are different, reads the newly selected simulation model from the model data base 1 and outputs the present newly selected simulation model to the simulation calculator 4a.

However, when a content of the selection condition of the model is to set a threshold value of a state of the moving subject and/or a state of the environment and designate simulation models which are different from each other with a border of this threshold value, for example, the model selector 3a may be constituted so that it uniquely changes a model which has been used at the present time to the selected model to omit the decision whether or not the newly selected simulation model is different from a simulation model which has been used at the present time.

Alternatively, in the model selector 3a, such model selection, such model decision and such model output are repeatedly operated from a start time of the simulation calculation to a finish time thereof.

In this case, examples of the model selector 3a are shown in FIGS. 9A through 9C. FIG. 9A illustrates “a case such that a model 2 is used if a vehicle density with respect to all segments and all times is larger than 40 cars/km and a model 1 is used if a vehicle density with respect to all segments and all times is not more than 40 cars/km”. In FIG. 9A, a model is selected on the basis of the information from the simulation calculator 4a and this condition.

FIG. 9B illustrates “a case such that, only in a segment A3, the model 2 is used if a vehicle density with respect to all times is larger than 40 cars/km and the model 1 is used in other cases”. In FIG. 9B, a model is selected on the basis of the information in the segment A3 from the simulation calculator 4a and this condition.

FIG. 9C illustrates “a case such that the model 2 is used if an average speed of a vehicle is lower than 20 km/h from 06:00 hrs to 09:00 hrs and the model 1 is used in other cases”. In FIG. 9C, a model is selected on the basis of the information of an average speed V from the simulation calculator 4a and this condition.

The simulation calculator 4a has a function to input a state of a moving subject and/or a state of an environment in the model selector 3a during the simulation calculation in addition to the function. Alternatively, simulation calculator 4a further has a function such that, if the simulation calculator 4a accepts a simulation model from the model selector 3a during the above simulation calculation, it continues the simulation calculation by using this newly accepted simulation model in place of the simulation model which is presently being used.

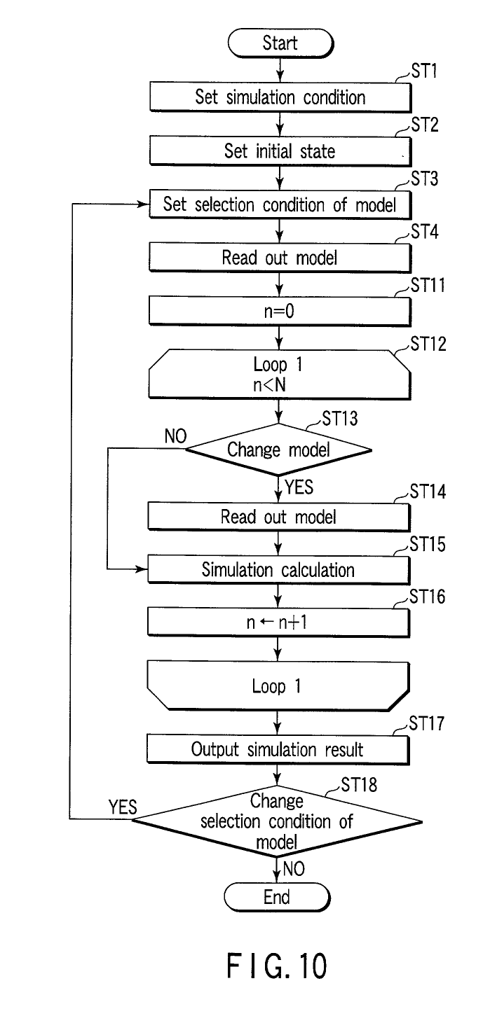

Next, the operation of the simulation system constituted as described above will be explained with reference to a flow chart shown in FIG. 10.

The procedures from setting a simulation condition in the step ST1 to reading of a model in the step ST4 are carried out in the same way as described above. However, a selection condition of a model in the step ST3 may be added to any one of the above-described (C1) through (C9) or the selection condition upon changing (C10) may be set by itself.

Next, the simulation calculator 4a starts the simulation calculation by using a simulation model accepted from the model selector 3a.

In this case, the simulation calculator 4a sets an initial value 0 to n representing a simulation time (ST11). During the simulation calculation, the procedures from the step ST13 to the step ST16 are repeated as a loop 1 from the simulation time 0 to NΔt (ST12). Alternatively, Δt represents a unit of time of the simulation and NΔt represents a simulation time.

Within this loop 1, the model selector 3a selects a simulation model on the basis of a state of the moving subject, a state of the environment and a selection condition of a model and the model selector 3a decides whether or not a simulation model should be changed depending on whether or not such that the simulation model selected in this time is different from the simulation model which is presently being used (ST13).

In this case, when both models are identical to each other, the process proceeds to step ST15. On the other hand, when both models are different, the model selector 3a decides that the model should be changed. Then, the model selector 3a reads out the simulation model that has been selected in the present time from the model data base 1 (ST14), so that the model selector 3a transmits it to the simulation calculator 4a.

The simulation calculator 4a performs simulation by using the simulation model decided on (ST15) and outputs a state of the moving subject and a state of the environment to the model selector 3a. Alternatively, the simulation calculator 4a increases n, representing a simulation time, by one (ST16) to return to the step ST13.

When n is identical to N, the simulation calculator 4a is pulled out from the loop 1 and it outputs a simulation calculation result to the output device 5.

The output device 5 displays the simulation calculation result and outputs it (ST17).

Hereinafter, as in the above case, a user who has seen the simulation calculation result changes a selection condition of a model so that it is selected whether or not a simulation should be carried out again (ST18). When the simulation should be carried out again, the same processing will be repeated, returning to the setting of the selection condition of the model in the step ST3.

As described above, according to the present embodiment, by setting a selection condition of a model by the use of the state of the moving subject and the state of the environment, it is possible to check a state during the simulation and change the model to an appropriate one dynamically. As a result, it is possible to realize the high precision and a short calculation time at the same time in the same manner as the first embodiment.

For example, as an error of the model with a low degree of the details is being increased, it is possible to satisfy the precision of the simulation result as well as to carry out the simulation having not so long calculation time by using a model with a high degree of the details only in a necessary portion and using a model with a low degree of the details other than the necessary portion if a selection condition of a model to select a mode with a high degree of the details is capable of being set.

For example, a time and a place are not capable of being designated, however, if a property such that an error is increased in a model with a low degree of detail under the state that the density of the moving subject is high is known in advance, by using this property, a model with a high degree of detail may be used under the state such that the density of the moving subject is high and a model with a low degree of detail may be used under the state such that the density of the moving subject is low.

Alternatively, a relation between a state of the subject and an error of the model can be reflected on the selection conditions by the following procedures (1) through (3), for example.

In other words, upon setting a selection condition, (1) with respect to a first simulation model with a certain degree of detail and a second simulation model with a degree of detail lower than the certain degree of detail, the simulation is calculated for each of the present simulation models.

(2) Respective simulation calculation results, error difference data of these both calculation results, usage data of respective simulation models and error difference data of the both usage data are outputted. Alternatively, the error difference data may be an index to represent the difference between the both data. For example, the difference data or the error ratio data may be available.

(3) When the error difference data of the both calculation results is large, a message is outputted to detect the usage data such that the error difference data is large and set a threshold value of the present usage data to a selection condition for changing a model. After that, the threshold value is set by the operation of the user.

Alternatively, the usage data represents a state of a subject such as a density. Additionally, it is decided whether or not the error difference data is large by the comparison of the calculation result of the error ratio with a predetermined reference value. However, the user may check whether or not the error difference data is large.

Third Embodiment

Next, as a third embodiment according to the present invention, an example in which a simulation system according to the first embodiment is applied to a traffic flow network will be explained below.

A simulation model of the traffic flow network is roughly divided into a micro model with a high degree of the details and a macro model with a low degree of the details.

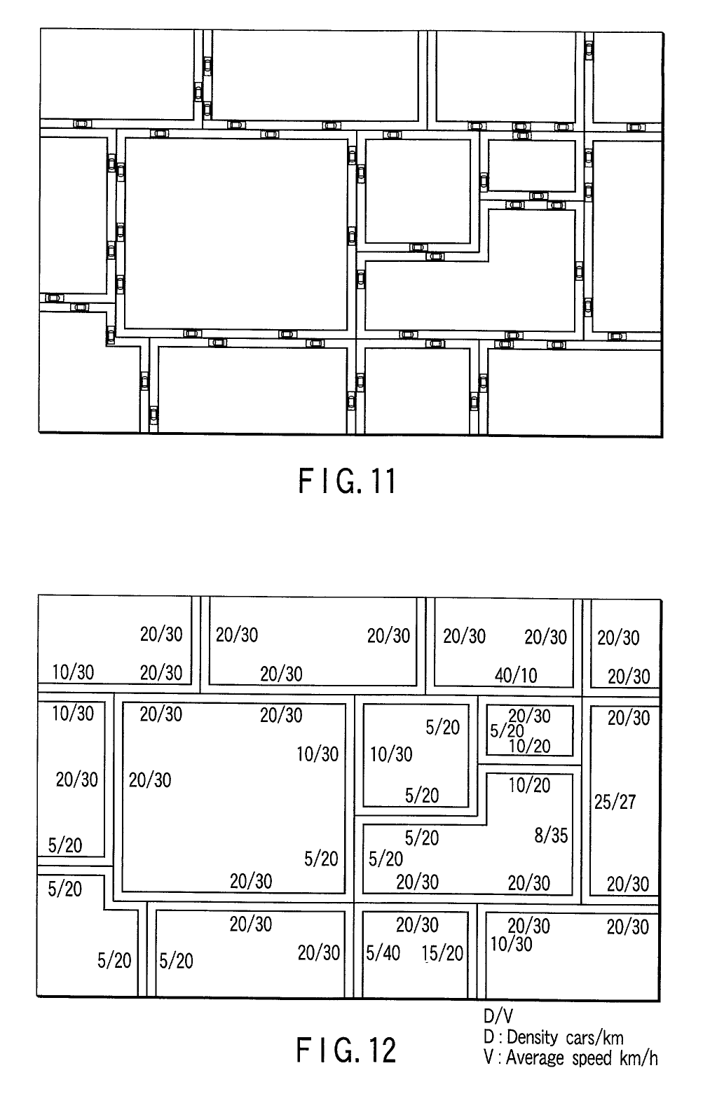

As shown in FIG. 11, the micro model comprises a simulation model to simulate a behavior of each vehicle. According to this simulation calculation, information such as a path of each vehicle, a travel time, a delay ratio, a position of a certain time, a speed, a travel time of each segment, an average speed, a traffic amount and the like are capable of being obtained. Alternatively, FIG. 11 illustrates a road in a network on which a vehicle travels and a vehicle on each segment and it further illustrates a snap shot seizing one time of a micro model. As a simulator of this micro model, for example, a MIC-STRAN (Microscopic Simulation of Traffic Network), which has been developed mainly by National Research Institute of Police Science, can be considered.

On the other hand, a macro model does not treat individual vehicles. However, as shown in FIG. 12, the macro model is a simulation model which treats a group of vehicles or a flow of the vehicles. According to this simulation calculation, the information such as a total travel time of the vehicle, an average speed, a density on a segment, a traffic amount and the like can be obtained. Alternatively, FIG. 12 illustrate a road in a network on which a vehicle travels, a density on each segment and an average speed and it further illustrates a snap shot seizing one time of a macro model. A density D and an average speed V are represented by D/V. A front part (left) defines the density D and a rear part (right) defines the average speed V. For example, 20/30 represents a density 20 cars/km and an average speed 30 km/h.

As a simulator of this macro model, for example, a TRANSYT (A Traffic Network Study Tool) or the like, which has been developed by a TRRL (TRL Transport Research Laboratory at present) in Great Britain, can be considered.

The present embodiment is constituted in such a manner that the micro model and the macro model of the traffic flow network have been registered in a model data base 1 in advance.

Alternatively, an applicable example of a selection condition of a model in the traffic flow network will be shown below.

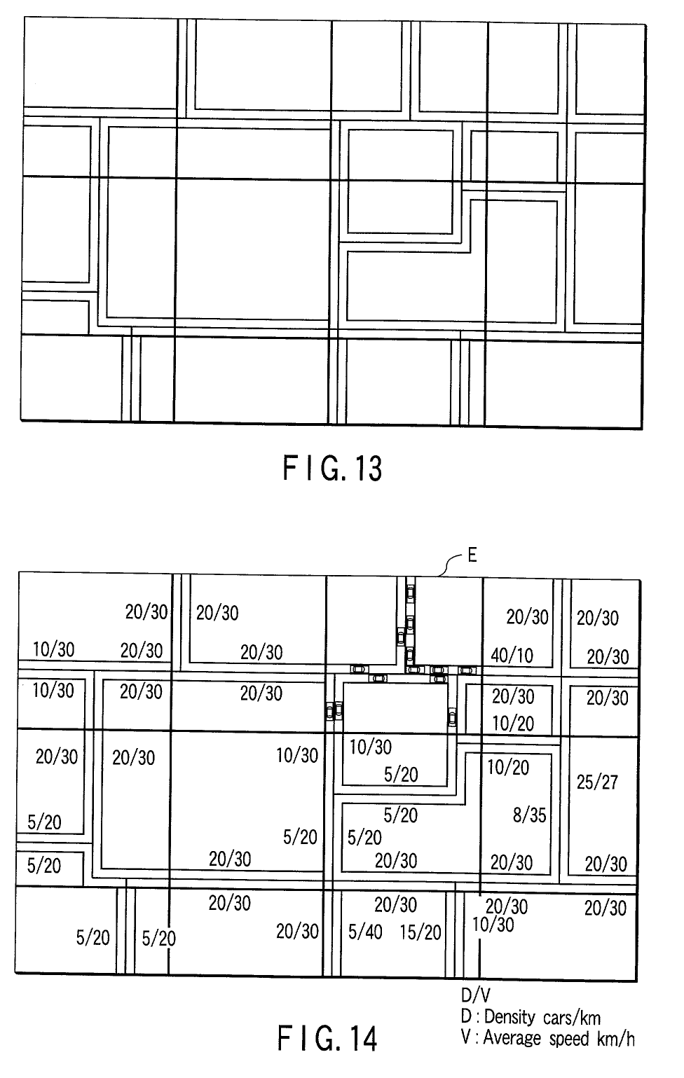

In the case of (C2), a space on a map is divided into certain segments. Alternatively, it may not be divided into certain segments, but it may be divided into, for example, a road segment unit. FIG. 13 illustrates an example such that a space on a map is divided into certain segments. According to this example, a segment is selected and a simulation model to be provided to this segment is selected. Assuming, for example, that the macro model is set in default, as shown in FIG. 14, a segment E to use a micro model is selected and a micro model is selected in association with the segment E.

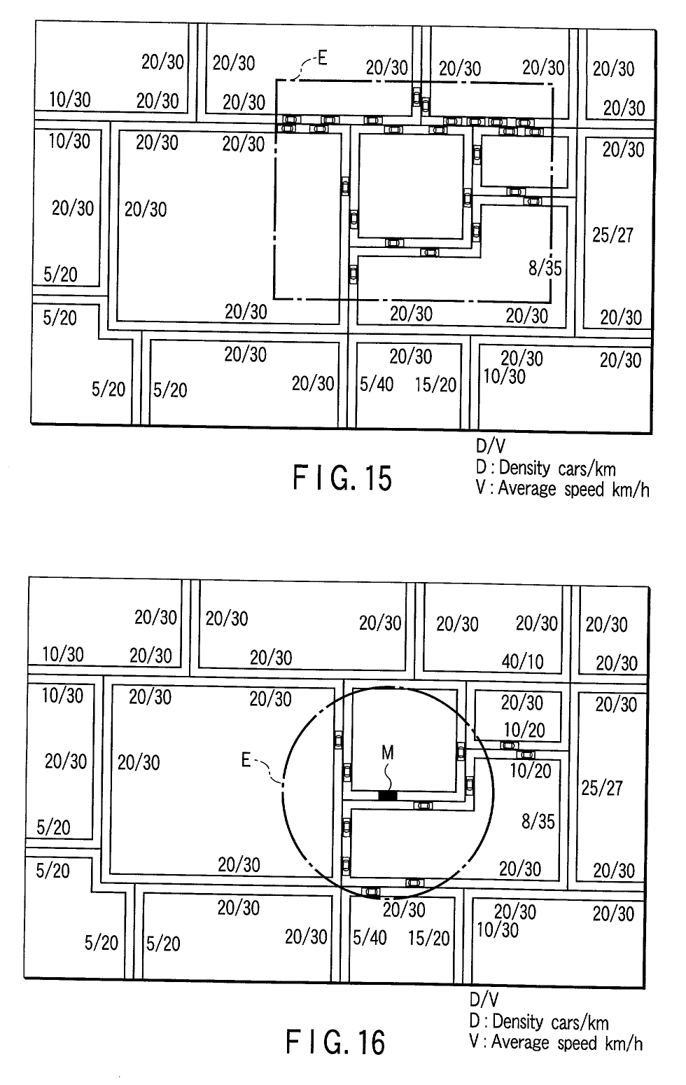

In the case of (C3), an arbitrary range on a map is selected and a simulation model to be applied to this range is selected. FIG. 15 illustrates the segment E in which a range circled by a dashed line is selected and a micro model is applied only in this segment E.

In the case of (C4), a simulation time is divided for each certain length of time and a simulation model to be applied to each time is selected.

In the case of (C5), an arbitrary time within a simulation time is designated and a simulation model to be applied to that time is selected.

In the case of (C6), a space is divided into certain segments, a simulation time is divided for each certain length of time and a combination of a time and a segment is designated, so that a simulation model to be applied to that time is selected.

In the case of (C7), a time and a space are arbitrarily divided and a simulation model to be applied to that region is selected.

In the case of (C8), a space is divided into several segments, a vehicle is selected and a simulation model to be applied to a segment in which that vehicle is located is selected.

In the case of (C9), a space is not divided, a vehicle is selected and a simulation model to be applied to a segment within a predetermined radius around that vehicle is selected. FIG. 16 is a schematic view for illustrating a case such that a vehicle is selected and a micro model is applied in the segment E as a circle around that vehicle. A vehicle M painted in black is a selected vehicle and a micro model is applied to the segment E shown by a circle of a dashed line. This is particularly preferable selection condition upon paying attention to a specified vehicle M moving between certain points. Alternatively, this circular segment E is further divided into several segments and a combination of a specified segment and/or a time in these segments and a model may be designated.

Next, the operation of a simulation system configured as described above will be explained below.

At first, if the simulation conditions such as a road network, geography, weather, a simulation time and the like are set by the operation of the user, the setting device 1 indicates a map on the basis of these information. Additionally, a selection condition of a model is set. In this case, for example, it is assumed that a selection condition of a model (C2) to designate a model for each segment is set.

Next, an initial state of a vehicle or a vehicle group is set for each segment. In a segment of the micro model, the number of the vehicles, an initial position of each vehicle and an initial speed are set. In a segment of the macro model, a density of the vehicles and an average speed are set for each segment.

Next, when the startup of a simulation is set, according to the model selector 3, a plurality of simulation models set, namely, a micro model and a macro model are read out from a model data base, respectively and they are outputted to the simulation calculator 4.

According to the simulation calculator 4, a simulation calculation is carried out on the basis of a simulation condition, an initial state and a simulation model.

In this case, the simulation calculation is carried out as changing the macro model and the micro model for each segment.

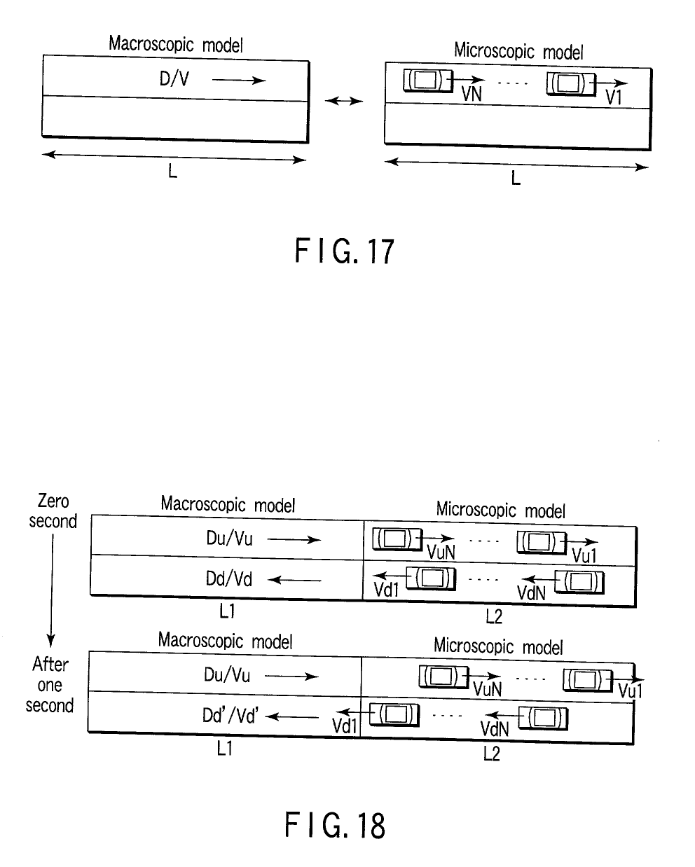

For example, as shown in FIG. 17, it is assumed that a segment length L km, the number of cars N on the segment, a position Xᵢ of each vehicle (i=1, 2, . . . , N) km and a speed Vᵢ (i=1, 2, . . . , N) km/h are known in the micro model and a segment length L km, a vehicle density D cars/km and a speed V km/h are known in the macro model.

When the macro model is changed into the micro model, on the basis of the vehicle density D cars/km and the segment length L km, the number of the vehicles on the segment is calculated as DL.

Next, a position of the DL cars of the vehicles on the segment and the speed of each vehicle are set. Briefly, all vehicles may be located at even intervals and they are set so that they travel at an average speed, respectively.

However, in accordance with a provability distribution such as a Poisson's distribution and a normal distribution or the like, spacing between the vehicles and/or the vehicle speed may be scattered. Alternatively, the moving subject having a property in its location may be located by using this property.

On the other hand, when a micro model is charged into a macro model, it is possible to calculate a vehicle density D=N/L cars/km from the number of the vehicles on the road N and the segment length L km. Alternatively, the average speed V km/h is calculated as shown in a next mathematical expression from a speed Vdi (i=1, 2, . . . , N) of each vehicle, so that they may be set as the vehicle density D of a macro model and the average speed V, respectively.

$$Average speed V = \frac{{\sum }_{i = 1}^{N} {Vd}_{i}}{N} km \text{/} h$$

Next, the movement of the vehicles in the models is considered in the case that a macro model and a micro model are adjacent each other. FIG. 18 is a view such that a macro model and a micro model are connected to each other.

At first, a flow of a vehicle from the macro model to the micro model is considered. If a density on a segment of the macro model is defined as Du cars/km and an average speed is defined as Vu km/h, an average moving distance per second is 1,000 Vu/3,600 m and the average number of the vehicles per meter is Du/1,000 cars. Therefore, the number of the vehicles which move from the macro model to the micro model becomes DuVu/3,600 cars.

In this case, while using a provability distribution such as a Poisson's distribution or the like and keeping the average number of the moved vehicles per second as DuVu/3,600 cars, timing at the vehicle is moving is scattered. Alternatively, the speed is scattered in the same way, so that the speed of each vehicle is decided so that the average speed becomes Vu km/h.

Next, a flow of a vehicle from the micro model to the macro model is considered. It is assumed that a density of the macro model is Dd, an average speed is Vd, the density of the macro model Dd is changed to a density Dd′ and the average speed Vd is changed to an average speed Vd′. A position and a speed of each vehicle is known in the micro model, so that the number of the vehicles which move from the micro model to the macro model per second M and a speed Vdₙ (n=1, . . . , M) of these vehicles are known. Accordingly, it can be appreciated that a density D'd of the macro model after one second is changed as shown in the following mathematical expression.

$$Density after 1 second {Dd}^{′} = \frac{Dd \times L1 + M - \frac{Dd \times Vd}{3600}}{L1}$$

Alternatively, it is appreciated that an average speed V'd after one second is changed as shown in the following mathematical expression.

$$Speed after 1 second {Vd}^{′} = \frac{( Dd \times L1 - \frac{Dd \times Vd}{3600} ) \times Vd + {\sum }_{n = 1}^{M} {Vd}_{n}}{Dd \times L1 - \frac{Dd \times Vd}{3600} + M}$$

In this way, it is possible to calculate the density of the vehicles and the vehicle speed in the case that the macro model and the micro model are adjacent each other.

By the way, a simulation calculation result as described above is outputted to the output device 5 and then, the output device 5 displays the simulation calculation result and outputs it.

Alternatively, as a result of the simulation calculation, when the user would like to know the behavior of each vehicle by changing a segment of a macro model into a micro model or the user would like to calculate the simulation quickly granted that the obtained result is rough, a corresponding segment is selected and a simulation model to be applied to that segment is changed, so that it is possible to calculate the simulation again.

As described above, according to the present embodiment, it is possible to obtain an effect as same as the first embodiment in the simulation calculation of the traffic flow network.

Next, the effect of the present embodiment will be explained complementarily. Designation of the models with different degrees of the details depending on the segments is capable of applied when, for example, a segment which is always vacant like a road of an area having no big city so that a driver is capable of traveling at the same speed and a segment which is always stuck in traffic like a road of a big city are congested. In other words, this is a system such that the decision of a state as in the second embodiment is not carried out with respect to the segment of which state is known in advance and a model is designated in advance. In this case, a time is also designated in advance.

FIG. 17 illustrates a narrow space, so that there is no problem if a micro model is applied. However, the micro model hardly can represent a wide area, for example, an entirety of the Kanto district or an entirety of Japan. Even if the micro model hardly can represent such a wide area, it takes a large amount of calculator resources and a very long calculation time. Therefore, it is needed to suppress the calculator resources and the calculation time by using the macro model. In other words, it is necessary to apply a model having an appropriate degree of the details depending on a size of an area to be simulated, the number of the moving subjects and the like according to a subject to be simulated.

For example, when the user would like to know the behavior of a specific vehicle in Tokyo by using a micro model, it seems that the behavior of a specific vehicle in Osaka hardly has an effect on the specific vehicle in Tokyo. Accordingly, the simulation calculation of the vehicle in Osaka may be carried out at a high speed even with a low degree of precision. In other words, a size of an error generated by a model with a low degree of the details is considered with respect to a calculation result of an intended simulation and a model with a low degree of the details is used in a portion with a small error, so that it is possible to suppress the simulation calculation time.

Additionally, according to the present embodiment, the selection condition of the model (C2) is taken as an example. However, it is needless to say that it is not limited to this but any one of other selection condition of the models (C1), (C3) through (C9) may be set.

Fourth Embodiment

Next, as a fourth embodiment of the present invention, an example such that a model changing function of the second embodiment is provided with respect to a simulation system of a traffic flow network according to the third embodiment.

In other words, the present embodiment serves to change a simulation model depending on a state defined by a calculation result in the simulation of the traffic flow network. Specifically, in a constitution shown in FIG. 8, a state of a vehicle during the simulation (a state of a group of vehicles) and a state of an environment are used as a selection condition of a model (C10).

For more information, as the selection condition of the model (C10), a state is used including a content to designate the simulation models which are different from each other with a border of a threshold value on the basis of a state of a subject and/or a state of an environment to be inputted from the simulation calculator 4a and a threshold value set in advance with respect to the state of the subject and/or the state of the environment. Alternatively, the selection condition of the model (C10) may be combined with other selection conditions of the model (C1) through (C9) capable of being used in the third embodiment.

Next, the operation of a simulation system configured as described above will be explained below.

The setting device 1 sets a simulation condition by the operation of the user.

Subsequently, the selection condition of the model is set on the model selector 3a. The selection condition of the model is set as a content of “if a density D of vehicles on a segment is not less than a certain threshold value, a micro model is used with respect to this segment”.

The model selector 3a evaluates the selection condition of the model in an initial state, reads out a simulation model to be used in the initial state from a model data base and outputs it to the simulation calculator 4a.

The simulation calculator 4a carries out the simulation calculation by using this simulation model. During the simulation calculation, the simulation calculator 4a inputs the state of the vehicle and/or the state of the environment in the model selector 3a.

The model selector 3a continues to evaluate a selection condition of a model on the basis of the state of the vehicle and/or the state of the environment to be inputted. Then, if the density of the vehicles on a certain segment is not less than a threshold value, the model selector 3a reads out a micro model from the model data base 1 to output it to the simulation calculator 4a. Alternatively, as same as the second embodiment, the model selector 3a may continue to compare the selected model with a model, which has been used in the present time to change the model upon selecting the different model.

The simulation calculator 4a transmits a calculation result to the output device 5, when an appropriate model is updated to a micro model in a segment of which density exceeds a threshold value, a simulation calculation is continued and then, it is finished. As same as the procedures described above, the steps ST17 to ST18 will be carried out.

As described above, according to the present embodiment, during the simulation calculation, the state of the vehicle and the state of the environment are observed and the selection condition of the model has been evaluated continuously. Then, if a model which is different from the present model, a model is read from the model data base 1 quickly to be outputted to the simulation calculator 4a, so that the mode used in the simulation calculator 4a is updated. In this way, even in the simulation calculation of the traffic flow network, the same effect as that of the second embodiment is capable of being obtained.

Next, an effect of the present embodiment will be explained complimentarily. A basic idea of the present invention is to use a model with a low degree of the details and switch the model with a low degree of the details to a model with a high degree of the details when an error of a simulation, namely, an error between the simulation and a real system is large. However, in order to know an error of the simulation, it is needed to compare a calculation result of the model with a low degree of the details with a calculation result of the high-precision model with a high degree of the details. As a result, in order to make the high-precision model with a high degree of the details calculate the simulation, the amount of the calculation has been large.

Therefore, the present embodiment is configured in such a manner that a relation between a state of the simulation calculation and an error in the simulation model is checked and if it is found that a state approaches one such that the error is increased as observing a state, the model is switched to a model with a high degree of the details.

For example, in the case of the traffic flow, it is assumed that an error becomes large in a macro model when the density of the vehicles becomes higher and the traffic is stuck. Then, as a selection condition of a model, such a condition is set that a model is switched to a model with a high degree of the details if the density of the vehicles on the segment becomes not less than a fixed value. Hereby, by observing the density of the vehicles on the segment during the simulation calculation, it is possible to decrease the error by switching the model.

Fifth Embodiment

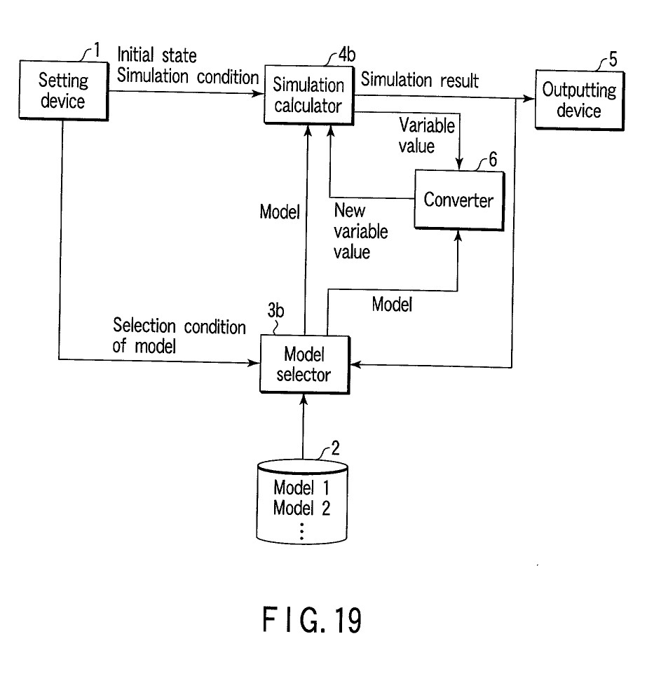

FIG. 19 is a block diagram for illustrating a constitution of a simulation system according to a fifth embodiment of the present invention.

In other words, the present embodiment comprises a modified embodiment of the second embodiment. According to the present embodiment, upon changing a simulation model with a low degree of the details to a simulation model with a high degree of the details, a variable is uniquely decided. Specifically, as shown in FIG. 19, a converter 6 is provided to convert a variable value of the present model to a variable value of a new model.

In this case, the converter 6 has a function to convert a variable value received from a simulation calculator 4b to a variable value of a new model on the basis of a state of a peripheral area and a state of an environment received from the simulation calculator 4b upon receiving a new simulation model from the model selector 3b and output the obtained variable value to the simulation calculator 4b.

Alternatively, when a model with a high degree of the details is changed to a model with a low degree of the details, even if the converter 6 is not provided, it is possible to decide a variable uniquely. However, when a model with a low degree of the details is changed to a model with a high degree of the details, it is not possible to decide a variable uniquely.

Therefore, the present embodiment is provided with the converter 6 capable of calculating a variable value which approximates a state of a real target system by using the information from a state of a periphery within a simulation space and an environment to perform the variable conversion.

In accordance with this, the model selector 3b has a function to further output a newly selected simulation model to the converter 6 in addition to the function of the model selector 3a.

The simulation calculator 4b has a function to input a state of a periphery and a state of an environment in a simulation model which has been used at the present time and a variable value of a simulation model which has been used at the present time in the converter 6, if the simulation calculator 4b receives a simulation model from the model selector 3b during the simulation calculation, in addition to the function of the model selector 4a.

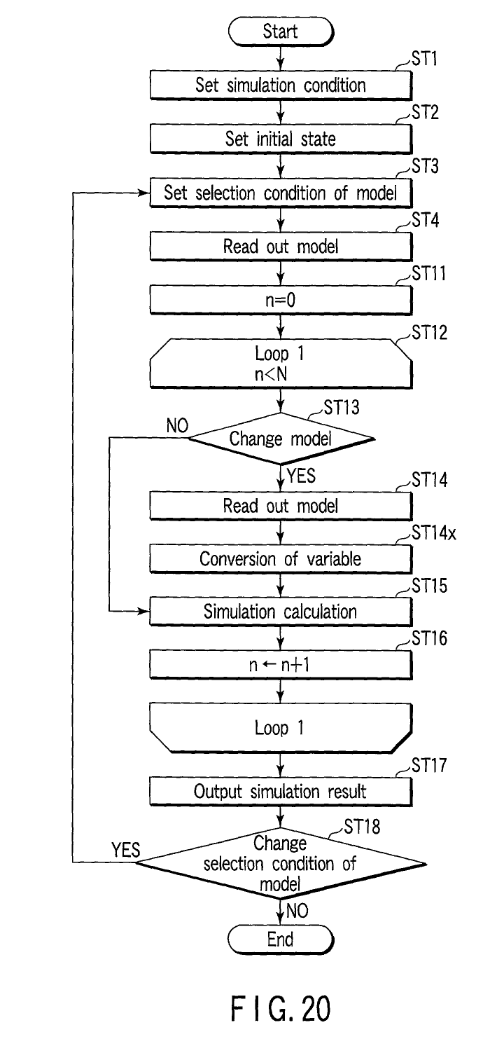

Next, the operation of a simulation system configured as described above will be explained with reference to a flow chart shown in FIG. 20. However, the procedures other than the conversion of a variable upon changing a model are carried out in the same way as described above, so that the explanations of the parts as same as described above are herein omitted.

By the way, in the step ST13, it is assumed that the model selector 3b decided that a model should be changed and read out a simulation model newly selected in this time, from the model data base 1 (ST14), so that the model selector 3b transmitted it to the simulation calculator 4b.

In this case, the model selector 3b also outputs a newly selected simulation model to the converter 6.

Alternatively, the simulation calculator 4b inputs a state of a periphery and a state of an environment in a simulation model which has been used at the present time and a variable value of a simulation model which has been used at the present time in the converter 6, if the simulation calculator 4b receives a simulation model from the model selector 3b during the simulation calculation.

When it received a new simulation model from the model selector 3a, the converter 6 converts a variable value of a model which has been used in the present time to a variable value of a new model on the basis of the state of the periphery and the state of the environment received from the simulation calculator 4b, (ST14x). Then, the converter 6 outputs the obtained variable value to the simulation calculator 4b.

Hereby, the simulation calculator 4b carries out the simulation calculation by using a new simulation model and its variable value (ST15) and it outputs the sate of the moving subject and the state of the environment to the model selector 3b.

The processing will be carried out in the same way as described above below.

As described above, according to the present embodiment, in addition to the effect according to the second embodiment, particularly upon converting a simulation model with a low degree of the details to a simulation model with a high degree of the details, the converter 6 converts a variable value of a simulation model with a low degree of the details to a simulation model with a high degree of the details on the basis of the state of the periphery and the state of the environment, so that it is possible to set a value which approximates a variable of a real target system to a simulation model.

Alternatively, when a selection condition of a model is designated only by a time, the input from the simulation calculator 4b in the model selector 3b is not needed.

sixth Embodiment

Next, as a sixth embodiment according to the present invention, an example such that the simulation system according to the fifth embodiment is applied to the traffic flow network will be explained with respect to the parts which are different from the parts.

The present embodiment illustrates a specific example of the converter 6. According to the present embodiment, the converter 6 decides a variable value as an arrangement of a vehicle on the basis of information of the peripheral area and a predetermined conversion rule, so that an arrangement of a vehicle of a simulation model approximates a real arrangement of a vehicle.

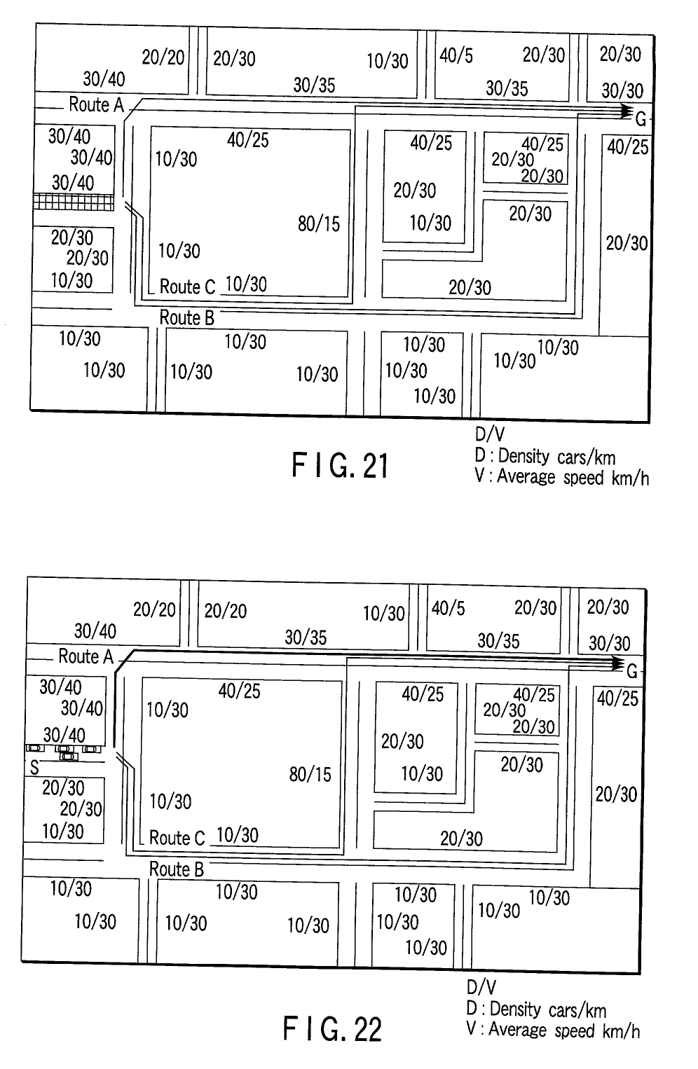

FIG. 21 illustrates a macro model of a road network in which a main road, namely, a broad road in the drawing comprises a four-lane road. In FIG. 21, it is assumed that the most of the vehicles which enter from a road S at a left end turn right after turning left and gets out from a road G at a right end. Under the state that a vehicle smoothly travels all through a road network, the most of the vehicles travel on a rout A as the shortest path.

Accordingly, if a link in a lattice pattern on the road S at the left end shown in FIG. 21 is changed to a micro model in the case that the vehicles travel smoothly, as shown in FIG. 22, it is seemed that many vehicles are arranged on a left traffic lane near to the route A.

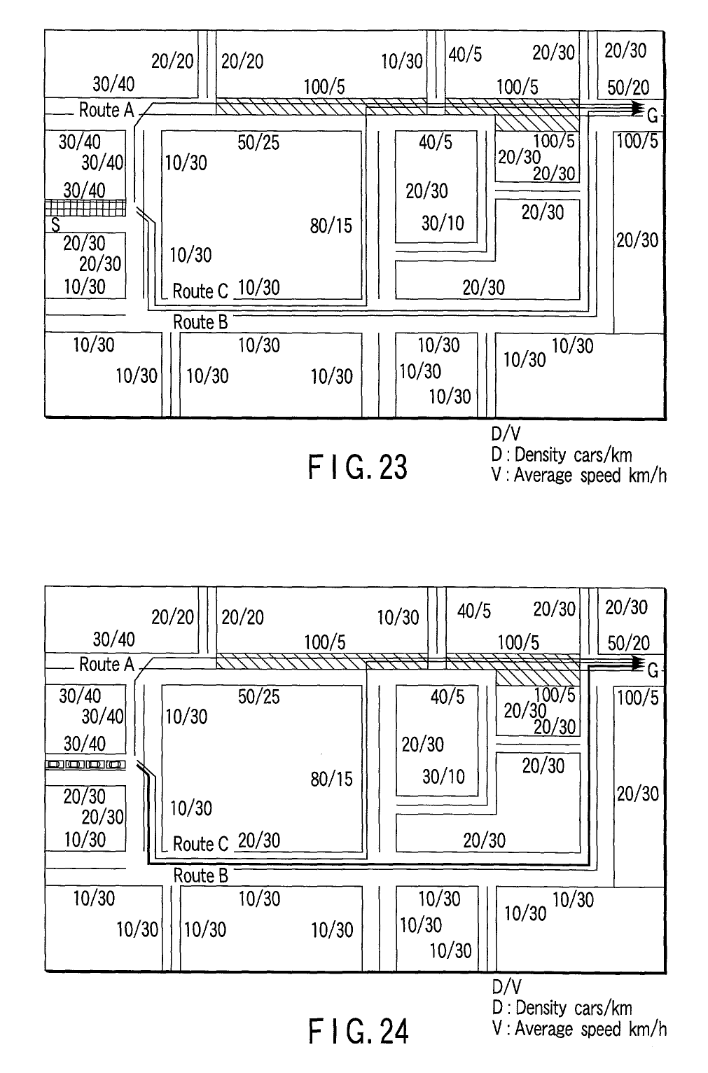

FIG. 23 illustrates a macro model of a road network, which is similar to the macro model of the road network shown in FIG. 21. The macro model shown in FIG. 23 is different from that shown in FIG. 21 in that a link portion with an oblique line painter on the route A is in a traffic jam with a density of 100 cars/km and an average speed of 5 km/h.

When a link of the road S is changed to a micro model in this traffic jam, if the traffic jam information is displayed in front of the link, each vehicle turns right to avoid the traffic jam and select a route B, so that as shown in FIG. 24, it is possible to predict that the density of the vehicles on the right side traffic lane is increased.

In this way, when the macro model is changed to the micro model, even if the information of the macro model in a portion in which the model is changed, for example, the information such that a density of 30 cars/km and an average speed of 40 km/h is the same, the state of the micro model happens to be different when the state of the periphery thereof is different.

Accordingly, as described above, the converter 6 decides a variable of a simulation model with a high degree of the details by using a state of a peripheral area and a state of an environment other than a variable value of a simulation model with a low degree of the details when the simulation model with a low degree of the details is converted to the simulation model with a high degree of the details.

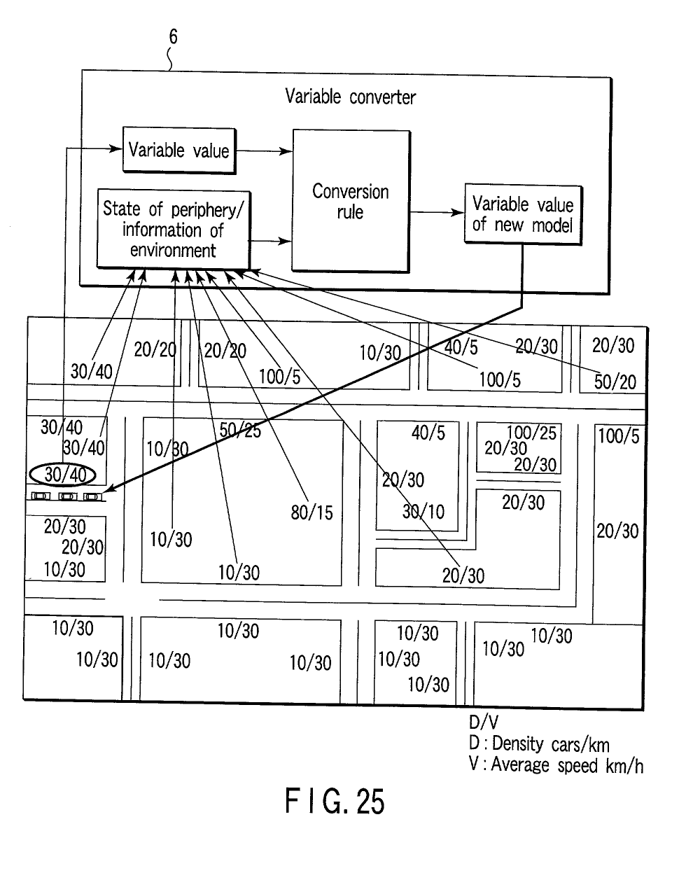

Specifically, as shown in FIG. 25, if a variable value of the macro model, a state of a periphery and a state of an environment are inputted from the simulation calculator 4b, the variable converting unit 6 calculates a variable value of the micro model by using a conversion rule on the basis of the inputted variable value of the macro model, the state of the periphery and the state of the environment. Then, the converter 6 outputs the obtained variable value to the simulation calculator 4b.

In this case, if an area in the traffic jam is detected from state information of a peripheral area, it is decided that each vehicle selects a path which avoids the area in the traffic jam by a conversion rule, so that an arrangement of each vehicle as a variable value of the micro model is decided with taking the traffic jam into account.

For example, in the variable converting unit 6, an average speed V_{L} of each link L on each route p (p=A, B, C) is obtained as “a state of a periphery” for respective routes A, B and C from the road S to the road G. In this case, on the basis of a link length L_{L} km of the link L and the average speed V_{L} km/h, it is possible that an average traveling time required for the passage of the link L is calculated as T_{L}=L_{L}/V_{L} h. Accordingly, an average traveling time Tₚ required for the travelling on the route p is represented by the following mathematical expression.

$${T}_{p} = {\sum }_{L = 1}^{N} {T}_{L} = {\sum }_{L = 1}^{N} \frac{{L}_{L}}{{V}_{L}} ( h )$$

wherein N is the number of the links on the route p

It is assumed that for example, a rule such that “the number of the vehicles for selecting the respective routes A, B and C is set so as to be in proportion with an inverse number of an average traveling time T_{A}, T_{B} and T_{C} required for the traveling on the respective routes A, B and C” is set as a conversion rule in the variable converting unit 6.

In this case, a ratio of the number of the vehicles for selecting the respective routes A, B and C is decided as the following mathematical expression.

$$\frac{1}{{T}_{A}} : \frac{1}{{T}_{B}} : \frac{1}{{T}_{C}}$$

Alternatively, it is found which traffic lane is selected by the respective routes A, B and C from two traffic lanes of a link in a lattice pattern, for example, the left side traffic lane is selected by the rout A, the right side traffic lanes are selected by the routes B and C. Therefore, the number of the vehicles on each traffic lane is obtained, so that it is possible to set a vehicle.

For example, as described above with reference to FIG. 24, if the route A is in the traffic jam, the travelling time of the route A is increased and the number of the vehicles is set to be less. Alternatively, in order for many vehicles to select the routes B and C, the number of the vehicles on the right side traffic lane is set to be more.

This conversion rule includes various contents. For example, a content of the conversion rule may be constituted in such a manner that, assuming that half of the vehicles do not receive the traffic jam information or half of the vehicles miss the traffic jam information, half of the vehicles select the shortest routes and remaining half thereof are changed in accordance with a peripheral state. Thus, the conversion rule is capable of being arbitrarily set with taking appropriate factors such as a diffusion rate of the traffic jam information and the like into account.

On the other hand, it is also conceived that the density D_{L} cars/km of each link L is obtained as “a state of a periphery” for the respective routes A, B and C from the road S to the road G in addition to the average speed V_{L} in the variable converting unit 6.

Similarly, it is possible to calculate the number of the vehicles on the link L as Z_{L}=D_{L}·L_{L} from the link length L_{L} km of the link L and the density D_{L} cars/km. Accordingly, the number of the vehicles travelling on the route p is represented by the following mathematical expression.

$${Z}_{p} = {\sum }_{L = 1}^{N} {Z}_{L} = {\sum }_{L = 1}^{N} {D}_{L} {L}_{L} ( cars )$$

Similarly, it is assumed that the conversion rule has a content of “the number of the vehicles for selecting the respective routes A, B and C is set so as to be in proportion with an inverse number of the numbers of the vehicles Z_{A}, Z_{B} and Z_{C} on the respective routes A, B and C”.

In this case, a ratio of the number of the vehicles for selecting the respective routes A, B and C is decided as the following mathematical expression.

$$\frac{1}{{Z}_{A}} : \frac{1}{{Z}_{B}} : \frac{1}{{Z}_{C}}$$

Further, similarly, the left side traffic lane is selected in the route A and the right traffic lanes are selected by respective routes B and C. Therefore, the number of the vehicles on each traffic lane is learned, so that it is possible to set a vehicle.

For example, according to the traffic jam described with reference to FIG. 24, the number of the vehicles on the route A is increased and the number of the vehicles to be distributed is decreased, so that the number of the vehicles on the right side traffic lane toward the routes B and C is set to be more. Alternatively, in a route that is too indirect, a distance for travelling becomes long and the number of the vehicles are also increased, so that the number of the vehicles to be distributed thereon is decreased.

Additionally, the term “periphery” according to the examples means a link included in the routes from the road S to the road G. However, the present invention is not limited to this but it may be arbitrarily changed to a range till the connecting 10 links ahead.

Alternatively, in FIG. 25, in order to simplify the explanation, one link within an area is only described. However, the model conversion is carried out with respect to all links in the area in actual, so that the same calculation is carried out with respect to all links.

As described above, according to the present embodiment, the variable converting unit 6 converts a variable value of a macro model into a variable value of a micro model on the basis of the variable value of the macro model, a state of a periphery and a state of an environment, further on the basis of a predetermined variable rule. Therefore, it is possible to easily and certainly obtain an effect of the sixth embodiment.

Seventh Embodiment

Next, as a seventh embodiment according to the present invention, an example such that a simulation system according to the fifth embodiment is applied to a simulation of a fishing industry will be explained with respect to the parts which are different from the parts.

The present embodiment illustrates another specific example of the variable converting unit 6. According to the present embodiment, as same as the sixth embodiment, the variable converting unit 6 decides an arrangement of a fishing ship (a variable value) on the basis of the information of a peripheral area, so that the arrangement of the fishing ship approximates a real arrangement of the fishing ship.

In this case, as the simulation of the fishing industry, a macro model which treats a ship group composed of a plurality of fishing ships as one element and a micro model which simulates the behavior of each ship belonging to the ship group are considered.

The macro model serves to verify in what route in seas of the world the ship group should cruise and in what position in seas of the world they should have fishing in order to have safe and effective fishing by the simulation.

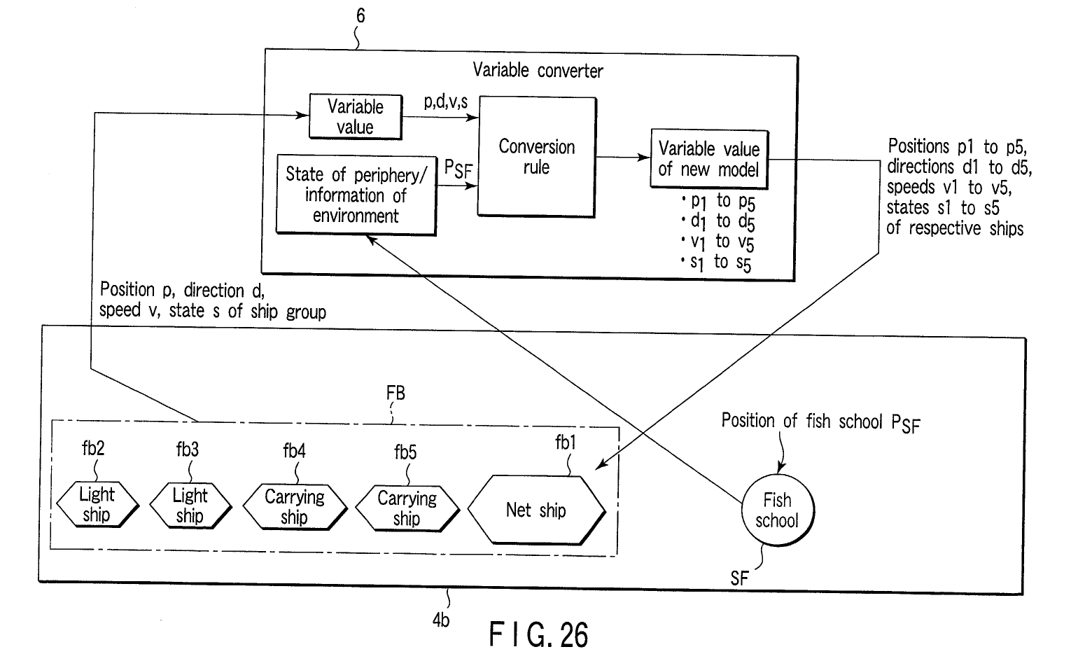

As shown in FIG. 26, the micro model serves to verify how respective fishing ships fb1 to fb5 within a ship group FB should surround a fish group SF to increase the catch or the like by the simulation.

Accordingly, if the macro model is used upon cruising and the micro model is used upon fishing, it is possible to save the calculation time of the simulation and the resource of the calculator and further, it is possible to obtain a simulation result with a high degree of the details.

For example, a round haul net fishery is generally operated by a ship group FB composed of two light ships fb2 and fb3 provided with a fish attraction lamp to collect a fish school and make it float and two carrying ships fb4 and fb5 to carry the collected fishes to a market. A main part of the fish school is a net ship fb1 to wind a net of a main ship.

In the macro model, five ships fb1 through fb5 are treated as an integral ship group FB. A position p, a direction d, a speed v and a state s of the ship group FB are inputted as a variable value of the macro model in the converter 6. As the state s includes a sailing state, namely, a state that the ship group FB is sailing, a searching state, namely, a state that the ship group FB is searching the fish group SF and a fishing state, namely, a state that the ship group FB is fishing in the fish group SF or the like.

In this macro model, for example, under the sailing state, the ship group FB proceeds at a predetermined speed, under the searching state, the ship group FB proceeds at a speed lower than that in the sailing state and under the fishing state, the ship group FB stops or moves at a low speed in the vicinity of the fish group SF.

On the other hand, in the micro model, each of the fishing ships fb1, fb2, fb3, fb4 and fb5 are treated in place of the integral ship group FB. Therefore, a conversion rule to convert a macro model into a micro model has a content such that a position p, a direction d and a speed v of the respective ships fb1 through fb5 are defined depending on the state s in accordance with a definition of the ship group FB for each role of the respective ships fb1 through fb5 as a net ship, a light ship and a carrying ship or the like. Alternatively, the definition of the ship group FB has a content including a role of respective fishing ships as described above and the number of the ships for each role. The content may accordingly include an object of the ship group, for example, a round haul net fishery or the like.

Next, upon changing the macro model to the micro model, a position P_{SF} of the fish group SF is inputted from the simulation calculator 4b in the converter 6 as a state of a periphery in addition to a variable value of the macro model.

The variable converting unit 6 calculates positions P₁ to p₅, directions d₁ to d₅, speeds v₁ to V₅ and states s₁ to s₅ of respective fishing ships fb1 to fb5 from the position p, the direction d, the speed V, and the state s of the ship group FB and the inputted position P_{SF} of the fish group SF in accordance with the conversion rule and it outputs them to the simulation calculator 4b.

Hereby, the positions p₁ to p₅, directions d₁ to d₅, speed v₁ to V₅ and states s₁ to S₅ of the respective fishing ships fb1 to fb5 on the simulator are decided for each of the fishing ships fb1 to fb5.

Alternatively, in the micro model decided in this way, for example, under the sailing state, the respective fishing ships fb1 to fb5 form an array and they sail at the same speeds each other. Under the searching state, the respective fishing ships fb1 to fb5 form an array and they proceed at a speed lower than that under the sailing state. Under the fishing state, on the basis of a distance between the respective fishing ships fb1 to fb5 and the found fish group SF and the rolls of the respective fishing ships fb1 to fb5, a position of the five fishing ships fb1 to fb5, namely, a formation is decided.

In other words, when the distance between the respective fishing ships fb1 to fb5 and the fish group SF is not less than a predetermined distance, the respective fishing ships fb1 to fb5 approach the fish group SF in a formation in a line. On the contrary, when the distance between the respective fishing ships fb1 to fb5 and the fish group SF is less than a predetermined distance, the respective fishing ships fb1 to fb5 approach the fish group SF in a formation to surround the fish group SF.

Alternatively, a formation in the case that the distance between the respective fishing ships fb1 to fb5 and the fish group SF is less than a predetermined distance is defined as an arrangement of the respective fishing ships fb1 to fb5, namely, a positional relation in advance on the basis of the rolls of the respective fishing ships fb1 to fb5.

Additionally, the distance between the respective fishing ships fb1 to fb5 and the fish group SF may be defined as a distance between a head fishing ship of the ship group FB and the fish group SF and it may be defined as a distance between a central fishing ship in the ship group FB and the fish group SF. Alternatively, it may be defined as a distance between an arbitrary standard position in the ship group SF and the fish group SF.

As described above, according to the present embodiment, the converter 6 converts a variable value of a macro model into a variable value of a micro model on the basis of the variable value of the macro model, a state of a periphery and a state of an environment, further on the basis of a predetermined variable rule. Therefore, it is possible to easily and certainly obtain an effect of the sixth embodiment.

Eighth Embodiment

Next, as an eighth embodiment according to the present invention, an example such that a simulation system according to the first, second or fifth embodiment is applied to an arm type robot as a manipulator will be explained.

The manipulator comprises a complex system such that joints thereof interfere them each other upon their movement each other and a nonlinear force such as a Coriolis force, a centrifugal force and the like act.

A simulation model of the manipulator is roughly divided into a nonlinear model with a high degree of the details and a linear model with a low degree of the details.

The nonlinear model is represented by a simultaneous differential equation including the interference between the joints and the nonlinear component. The nonlinear model has a property such that it takes a time in order to solve the simultaneous differential equation.

On the other hand, the linear model is a model which approximates linearly the nonlinear model in a certain state. The linear model has a property such that an error is not so large under the state that it is nearly linearized but a large error is possibly generated if the state is changed, since the attribute is extremely changed depending on a state of the manipulator, namely, the changing of a posture thereof, for example, the attribute is extremely changed in the state that it extends an arm and the state that it folds the arm.

The present embodiment is constituted in such a manner that a nonlinear model and a linear model of such a manipulator are registered in the model data base 1 in advance.

As a selection condition of a model, for example, in the case of (C2), a movable range of a hand is divided into some segments and a model to be used in each segment is directly designated. Alternatively, in the base of (C10), a model is switched depending on a posture and a speed of the manipulator.

Additionally, upon converting the nonlinear model and the linear model, the simulation calculators 4, 4a and 4b convert a model by switching the simultaneous differential equation to its linear approximate equation on the basis of a predetermine conversion rule. Then, the simulation calculators 4, 4a and 4b continue the simulation calculation by using an angle of the joint to be measured and an angular speed as they are.

Alternatively, as a predetermined conversion rule, for example, a conversion equation to relate the coefficients and the variables in the both equations is available so that a variable value in the linear approximate equation of the linear model is capable of being converted uniquely into a variable value within the simultaneous differential equation of the nonlinear model.

According to the constitution, it is also possible to obtain the same effect as that of the first, second or fifth embodiment in the simulation calculation of the manipulator.

Ninth Embodiment

Next, as a ninth embodiment according to the present invention, an example such that a simulation system according to the first, second or fifth embodiment is applied to a communication network will be explained.

The simulation of the communication network is roughly divided into a micro model with a high degree of the details and a macro model with a low degree of the details.

The micro model simulates the processing operation and the communication operation of a packet, an application server, a rooter and the like.

The macro model simulates uses an average value as the processing time of the application server and simulates the communication operation including an average communication time from a band width and a volume of the communication.

The present embodiment is constituted in such a manner that a micro model and a macro model of such a communication network are registered in the model data base 1 in advance.

As a selection condition of a model, for example, in the case of (C6), the communication network is divided by a time and a space, so that a model to be used in each range is directly designated. Alternatively, in the case of (C10), for example, if the density of the communication is increased, a model to be used is switched to a micro model.

As same as the traffic network, the simulation calculators 4, 4a and 4b continue the simulation calculation by using the conversion calculation between the average value and each value and a predetermined conversion rule so as to connect the macro model with the micro model and switch them.

Alternatively, as a predetermined conversion rule, for example, a content is available to define the number of each application server, a processing capability for each application server, the number of each rooter, a processing capability for each rooter and the arrangement of a server with each processing capability and a rooter with each processing capability or the like.

According to the constitution, it is also possible to obtain the same effect as that of the first, second or fifth embodiment in the simulation calculation of the communication network.

Tenth Embodiment

Next, as a tenth embodiment according to the present invention, an example such that a simulation system according to the first, second or fifth embodiment is applied to a business process will be explained.

As the business process, for example, a routine operation or the like such as a window operation in a bank or the like is applicable.

The business process is roughly divided into a micro model with a high degree of the details and a macro model with a low degree of the details.

The micro model serves to simulate the business process by using the arrangement of each person and the processing speed of an individual or the like.

The macro model serves to simulate the business process by using the density of population of a department and a section, an average processing speed a department and a section and the like.

The present embodiment is constituted in such a manner that these micro model and macro model are registered in the model data base 1 in advance. Alternatively, the density of population of the department and the section is associated with the density of the vehicles D and the average processing speed of the department and the section is associated with the average speed V, so that it is possible to convert the macro model into the micro model as same as the simulation of the traffic network.

Alternatively, as a predetermined conversion rule, for example, a content is available to convert the density of population and the average processing speed of the macro model into the arrangement of each person and the processing speed of an individual of the micro model on the basis of the arrangement of each person and the processing speed of an individual and an attendance state of each person, an approval relation and the like.

According to the constitution, it is also possible to obtain the same effect as that of the first, second or fifth embodiment in the simulation calculation of the business process.

Alternatively, the embodiment and a method described in the embodiment may be stored in a floppy disk, a magnetic disk such as a hard disk and the like, an optical disk such as a CD-ROM, a DVD and the like, an optical magnetic disk (MO) and a storage medium such as a semiconductor memory and the like to be distributed as a program capable of being executed by a computer.

Additionally, if this storage medium is a storage medium capable of storing a program and capable of being read by the computer, any storage system may be applied to this storage medium.

Additionally, an operating system working on the computer on the basis of setting of a program installed from the storage medium in the computer and a middle wear or the like such as a data base managing software, a network software and the like may execute a portion of each processing in order to realize the present embodiment.

Further, the storage medium according to the present embodiment include not only a medium independent of the computer but also a storage medium to download a program transmitted by the LAN, Internet and the like and store or temporarily store it.

Further, in the present invention, the number of the storage media is not limited to one and a plurality of storage media may perform the processing according to the present embodiment. In this case, any medium constitution may be available.

The computer according to the present invention performs each processing in the present embodiment on the basis of the program stored in the storage medium. Any medium constitution such as an apparatus composed of one personal computer or the like and a system in which a plurality of devices are connected by a network or the like.

Alternatively, the computer according to the present invention is not limited to a personal computer but it includes a calculation processing device included in the information processing equipment, a microcomputer and the like. The computer according to the present invention names generically equipments and devices capable of realizing a function of the present invention by a program.

Further, the present invention is not limited to the above respective embodiments and the present invention is capable of being variously modified within a range without departing from the scope thereof in the execution phase. Alternatively, respective embodiments may be combined appropriately as much as possible. In this case, an effect due to the combination will be obtained. Further, the respective embodiments include the inventions in various stages, so that various inventions are capable of being extracted by an appropriate combination of the disclosed plural components. For example, in the base that the invention is extracted by omitting some components from all components indicated in the embodiments, a well known common art compensates for the omitted components appropriately upon executing the extracted invention.

As described above, according to the present invention, it is capable of providing a simulation program product capable of satisfying a request with respect to the simulation precision and a request with respect to the calculation time, a method thereof and a system thereof.

What is claimed is:

1. A simulation program product for controlling a computer having a model data base,
said product storing a plurality of simulation models, which simulate the operation of a subject, and comprising:
condition inputting means for causing the computer to set an initial state of the subject to be simulated, a simulation condition and a selection condition of the simulation model;
model selecting means for causing the computer to select said simulation model on the basis of said set selection condition of the simulation model and to read out the selected simulation model from said model data base;
simulation calculating means for causing the computer to apply said set initial state of the subject and said set simulation condition to said read out simulation model and to calculate the simulation; and
result outputting means for causing the computer to output a result of said simulation calculation.

2. A simulation program product for controlling a computer having a model data base, said product storing a plurality of simulation models, which simulate the operation of a subject, and comprising:
condition inputting means for causing the computer to set an initial state of the subject to be simulated, a simulation condition and a selection condition of the simulation model;
model selecting means for causing the computer to select said simulation model on the basis of at least one state of said subject state and said environment state and said set selection condition of the simulation model and to read out the selected simulation model from said model data base;
simulation calculating means for causing the computer to apply said set initial state of the subject and said set simulation condition to said read out simulation model to calculate the simulation as well as for causing the computer to input at least one state of said subject state and said environment state obtained from the calculation in said model selecting means; and
result outputting means for causing the computer to output a result of said simulation calculation.

3. A simulation program product according to claim 2, wherein said selection condition has changing information to change the selected simulation model and the changing information includes a content, said content is defined by accordance with a state of a subject and/or a state of an environment to be inputted from said simulation calculating means and a threshold value set in advance with respect to the state of said subject and/or said state of said environment, said content designates simulation models which are different from each other with a border of said threshold value are designated.

4. A simulation program product according to claim 3, further comprising variable converting means for causing the computer to read out a variable value of a present simulation model from said simulation calculating means, when the selected simulated model is changed by the changing information to convert this variable value into a variable value of a simulation model newly selected by said model selecting means and to input the obtained variable value in said simulation calculating means.

5. A simulation program product according to claim 4, wherein said variable converting means includes means for carrying out the conversion of said variable value on the basis of a conversion rule, which describes a conversion relation of the variable values between the models, by using a state of a periphery and a state of an environment to be obtained from said simulation calculating means.

6. A simulation program product according to claim 1, wherein said selection condition includes designating a simulation model directly.

7. A simulation program product according to claim 1, wherein said selection condition includes dividing a space in which said subject operates into some segments and designating a simulation model for each segment.

8. A simulation program product according to claim 1, wherein said selection condition includes designating a partial segment of said space in which the subject operates as well as designating a simulation model in the segment.

9. A simulation program product according to claim 1, wherein said selection condition includes dividing a simulation time into a plurality of times and designating a simulation model for each time.

10. A simulation program product according to claim 1, wherein said selection condition includes designating a partial time of the simulation time as well as designating a simulation model correspond to the simulation time.

11. A simulation program product according to claim 1, wherein said selection condition includes dividing a space in which said subject operates into a plurality of segments, dividing the simulation time into a plurality of times and designating a simulation model in association with a combination of each time and each segment.

12. A simulation program product according to claim 1, wherein said selection condition includes designating a partial time of the simulation time as well as designating a partial segment in said space in which the subject operates and designating a simulation model in association with a combination of the times and the segments.

13. A simulation program product according to claim 1, wherein said selection condition includes dividing a space in which said subject operates into a plurality of segments and designating a simulation model in a segment in which said subject is located.

14. A simulation program product according to claim 1, wherein said selection condition includes designating said subject and designating a simulation model in association with an area in a predetermined range of which the approximate center is the subject.

15. A simulation program product according to claim 1, further comprising data calculating means for causing the computer to calculate used data of a simulation model after switching from used data of a simulation model before switching on the basis of a relation of the mutual used data in two simulation models of a subject to be switched upon said switching.

16. A simulation method utilizing a model data base in which a plurality of simulation models simulating the operation of the subject are stored, comprising:
inputting a condition to set an initial state of said subject, a simulation condition and a selection condition of the simulation model;
selecting said simulation model on the basis of said set selection condition of the simulation model and reading out the selected simulation model from said model data base;
applying said set initial state and said set simulation condition to said read out simulation model and calculating a simulation; and
outputting a calculation result by said simulation calculating step.

17. A simulation method utilizing a model data base in which a plurality of simulation models simulating the operation of the subject are stored, comprising:
inputting a condition to set an initial state of said subject, a simulation condition and a selection condition of the simulation model;
selecting said simulation model on the basis of at least one of said subject state and said environment state and said set selection condition of the simulation model and reading out the selected simulation model from said model data base;
applying said set initial state and said set simulation condition to said read out simulation model and calculating a simulation as well as inputting at least one of said subject state and said environment state obtained from the calculation, in said model selecting means; and
outputting a result of said simulation calculating.

18. A simulation method according to claim 17,
wherein said selection condition has changing information to change the selected simulation model and said changing information includes a content, said content is defined by accordance with a state of a subject and/or a state of an environment to be inputted from said simulation calculating step and a threshold value set in advance with respect to said state of said subject and/or said state of said environment, said content designates simulation models which are different from each other with a border of said threshold value are designated.

19. A simulation method according to claim 18, further comprising the step of reading out a variable value of a present simulation model from said simulation calculating step, when the selected simulated model is changed by the changing information, converting this variable value into a variable value of a simulation model newly selected by said model selecting step and inputting the obtained variable value in said simulation calculating step.

20. A simulation method according to claim 19,
wherein said variable converting step includes a step for carrying out the conversion of said variable value on the basis of a conversion rule, which describes a conversion relation of a variable value between the models, by using a state of a periphery and a state of an environment to be obtained from said simulation calculating step.

21. A simulation method according to claim 17, further comprising:
calculating a simulation for each simulation model with respect to a first simulation model with a certain degree of details and a second simulation model with a degree of details, which is lower than that of the first simulation model upon setting said selection condition;
as a result of calculation of said respective simulations, outputting error differential data of said both calculation results, used data of said respective simulation models and error differential data of said both used data; and
detecting the used data in which the error differential data is large when the error differential data is large as a result of said both calculations and setting a threshold value of the used data into a selection condition for said switching.

22. A simulation system for utilizing a model data base which stores a plurality of simulation models, which simulate the operation of a subject comprising:
a setting device which sets an initial state of said subject, a simulation condition and a selection condition of said simulation model;
a model selector which selects a simulation model on the basis of the selection condition set by said setting device to read out the simulation model from said model data base;
a simulation calculator which calculates the simulation by using a simulation model read out from said model selector on the basis of said initial state and said simulation condition set by said setting device; and
an outputting device which outputs the calculation result by said simulation calculator.

23. A simulation system for utilizing a model data base which stores a plurality of simulation models, which simulate the operation of a subject comprising:
a setting device which sets an initial state of said subject, a simulation condition and a selection condition of said simulation model;
a model selector which selects said simulation model on the basis of at least one state of said subject state and said environment state and said set selection condition of the simulation model to read out the selected simulation model from said model data base;
a simulation calculator which applies said set initial state and said set simulation condition to said read out simulation model to calculate the simulation as well as inputs at least one state of said subject state and said environment state to be obtained from the calculation; and
an outputting device which outputs the calculation result by said simulation calculator.

24. A simulation system according to claim 23,
wherein said selection condition has changing information to change the selected simulation model and the changing information includes a content, said content is defined by accordance with a state of a subject and/or a state of an environment to be inputted from said simulation calculator and a threshold value set in advance with respect to said state of said subject and/or said state of said environment, said content designates simulation models which are different from each other with a border of said threshold value are designated.

25. A simulation system according to claim 24, further comprising a variable converter which reads out a variable value of a present simulation model from said simulation calculator, when the selected simulated model is changing by the changing information, converts this variable value into a variable value of a simulation model newly selected by said model selector and inputs the obtained variable value in said simulation calculator.

26. A simulation system according to claim 25,
wherein said variable converter includes means for carrying out the conversion of said variable value on the basis of a conversion rule, which describes a conversion relation of the variable values between the models, by using a state of a periphery and a state of an environment to be obtained from said simulation calculator.
